(19) United States
(12) Patent Application Publication
(10) Pub. No.: US 2025/0362503 A1
(43) Pub. Date: Nov. 27, 2025

(54) HEAD MOUNT DISPLAY DEVICE WITH ENHANCED COLOR GAMUT

(71) Applicant: CHUNG ANG UNIVERSITY INDUSTRY ACADEMIC COOPERATION FOUNDATION, Seoul (KR)

(72) Inventors: Young Wan CHOI, Seoul (KR); Jae Sang LEE, Seoul (KR); Woo June CHOI, Busan (KR); Seong Hyeon CHO, Seoul (KR)

(21) Appl. No.: 18/788,421

(22) Filed: Jul. 30, 2024

(30) Foreign Application Priority Data
May 24, 2024 (KR) 10-2024-0068059

(51) Int. Cl. G02B 27/01; G03H 1/04

(52) U.S. Cl. CPC G02B 27/0172; G03H 1/0402; G02B 2027/0118; G02B 2027/0174; G03H 2001/0439; G03H 2222/13; G03H 2223/22; G03H 2223/24

(57) ABSTRACT

A head mount display device with an enhanced color includes: an optical output device that outputs light corresponding to an image to be output on a head mount display; a first diffraction grating that diffracts the output light; and a waveguide that totally reflects light diffracted by the first diffraction grating; and a second diffraction grating that diffracts and outputs the totally reflected light, in which, in the first diffraction grating and the second diffraction grating, pitches of R, G, and B of subpixels constituting an image are determined according to a predetermined standard.

### CROSS-REFERENCE TO RELATED APPLICATIONS

This application claims the priority of Korean Patent Application No. 10-2024-0068059 filed on May 24, 2024, in the Korean Intellectual Property Office, the disclosure of which is incorporated herein by reference.

### BACKGROUND

### Field

The present disclosure relates to a head mount display device with an enhanced color gamut using a spatially modulated diffraction grating (SMDG).

### Description of the Related Art

A head mount display device is mainly used to implement virtual reality (VR) or augmented reality (AR), and refers to a head mount display device. The head mount display device may implement a display as a wearable device in the form of glasses, and thus, has the characteristics of overcoming the inevitable trade-off relationship between the portability of a mobile device and the size of a screen.

A method of implementing a head mount display device may be broadly classified into two types.

First, a method of using a micro display device displays virtual content by disposing a device composed of a combination of pixels in units of micrometers or less in front of user's eyes.

On the other hand, a light field display is a method of displaying virtual content by irradiating light waves and projecting the light waves onto a user's retina without using a display device.

Since the light field display does not dispose the display device in front of the user's eyes, there are methods of alleviating or eliminating a vergence accommodation conflict (VAC). However, there is a problem that aberrations occur due to an optical system involved in transmitting light from a light source to human eyes, deteriorating the quality of images.

Here, a chromatic aberration is a representative optical aberration, and is a phenomenon that, when light of different wavelengths is refracted or diffracted by an optical system, an optical path changes, and therefore, each light does not converge at one point. In particular, the diffraction grating mounted on a waveguide display is vulnerable to the chromatic aberration.

Research is currently underway to improve characteristics that are vulnerable to the chromatic aberration. Representative research includes a method of stacking a diffraction grating in multiple layers, a method of controlling a recording time when manufacturing a holographic optical element (HOE) which is a type of diffraction grating, etc.

However, since the method is optimized based on measured experimental data, reproducibility is low, and there are limitations in designing and manufacturing a diffraction grating, so there are limitations in optimizing R, G, and B output intensities.

Therefore, there is an emerging need for a head mount display device capable of solving the chromatic aberration problem occurring in diffractive optical devices.

### SUMMARY

An object of the present disclosure is to provide a head mount display device capable of enhancing color gamut and improving a chromatic aberration problem.

In order to achieve one object of the present disclosure, according to an aspect of the present disclosure, a head mount display device with an enhanced color gamut includes: an optical output device that outputs light corresponding to an image to be output on a head mount display; a first diffraction grating that diffracts the output light; a waveguide that totally reflects light diffracted by the first diffraction grating; and a second diffraction grating that diffracts and outputs the totally reflected light, in which, in the first diffraction grating and the second diffraction grating, pitches of R, G, and B of sub-pixels constituting an image are determined according to a predetermined standard.

Preferably, the pitches of the R, G, and B may be determined based on an optical efficiency spectrum of each of the R, G, and B.

Preferably, the pitches of each of R, G, and B may be determined so that the optical efficiency spectrum of each of the R, G, and B is the same within a predetermined range.

Preferably, the optical efficiency spectrum of each of the R, G, and B may be calculated as Equation 1 below.

$${η}_{SMDG , B} ( λ ) = {η}_{B} ( λ ) \times \frac{{p}_{sub , B}}{p} , ( 450 nm < λ < 490 nm ) \\ {η}_{SMDG , G} ( λ ) = {η}_{G} ( λ ) \times \frac{{p}_{sub , G}}{p} , ( 530 nm < λ < 590 nm ) \\ {η}_{SMDG , R} ( λ ) = {η}_{R} ( λ ) \times \frac{{p}_{sub , R}}{p} , ( 630 nm < λ < 700 nm ) \qquad [ Equation 1 ]$$

Here, η_{SMDG,R}(λ), η_{SMDG,G}(λ), and η_{SMDG,B}(λ) denote the optical efficiency spectrum of R, G, and B light sources, η_{WG,R}(λ), η_{WG,G}(λ), and η_{WG,B}(λ) denote an optical efficiency spectrum of a hologram optical element (HOE)-based waveguide display recorded in monochrome for a single light source for each of the R, G, and B, p_{sub,R}, p_{sub,G}, and p_{sub,B} denote pitch sizes of R, G, and B subpixels, respectively, and p denotes a pitch of a unit pixel.

Preferably, the pitches of each of the R, G, and B may be determined based on the optical efficiency spectrum and sensitivity spectrum of each of the R, G, and B.

Preferably, the pitches of each of the R, G, and B may be determined so that stimulus values calculated using the optical efficiency spectrum and sensitivity spectrum of each of the R, G, and B are the same within a predetermined range.

Preferably, the stimulus values of each of the R, G, and B may be calculated as Equation 2 below.

$$B ( λ ) = {\int }_{450 nm}^{490 nm} I ( λ ) \times {S}_{B} ( λ ) d λ \\ G ( λ ) = {\int }_{530 nm}^{590 nm} I ( λ ) \times {S}_{G} ( λ ) d λ . \\ R ( λ ) = {\int }_{630 nm}^{700 nm} I ( λ ) \times {S}_{R} ( λ ) d λ \qquad [ Equation 2 ]$$

Here, R(λ), G(λ), and B(λ) denote the stimulus value of each of the R, G, and B, I(λ) denotes a light output spectrum, and S_{R}(λ), S_{G}(λ), and S_{B}(λ) denote the sensitivity spectrum of each of the R, G, and B.

Preferably, the first diffraction grating and the second diffraction grating may be one of a hologram optical element (HOE), a binary grating, a slanted grating, and a blazed grating.

According to the head mount display device with an enhanced color gamut of an exemplary embodiment of the present disclosure, it is possible to expand the color reproduction range of the head mount display device and improve the chromatic aberration problem by using the diffraction grating alone without using a separate optical element.

In addition, according to the head mount display device with an enhanced color gamut of an exemplary embodiment of the present disclosure, by adjusting the pitches of subpixels according to an optical efficiency spectrum for each wavelength band, it is possible to facilitate the customized optimization for diverse requirements of the CCD camera, the detector such as the human eye, and the observer.

In addition, according to the head mount display device with an enhanced color gamut according to an exemplary embodiment of the present disclosure, by expanding the color expression range of the VR or AR display, it is possible to improve the immersion of VR or AR.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram showing a head mount display device with an enhanced color gamut according to an exemplary embodiment of the present disclosure;

FIGS. 2A to 2C are photomask pattern diagrams for describing a pixel pitch according to an exemplary embodiment of the present disclosure;

FIGS. 3A and 3B are diagrams for describing a method of implementing a HOE-type spatially modulated diffraction grating according to an exemplary embodiment of the present disclosure;

FIG. 4 is a diagram for describing step-by-step the implementation of the HOE-type spatially modulated diffraction grating according to the exemplary embodiment of the present disclosure;

FIG. 5 is a diagram illustrating an image simulation result of the head mount display device with an enhanced color gamut according to the exemplary embodiment of the present disclosure;

FIG. 6 is a diagram illustrating an optical efficiency spectrum of a HOE-based waveguide display recorded in monochrome according to an exemplary embodiment of the present disclosure;

FIGS. 7A and 7B are diagrams for describing a subpixel pitch of a head mount display device with an enhanced color gamut according to another exemplary embodiment of the present disclosure;

FIGS. 8A and 8B are diagrams for describing the subpixel pitch of the head mount display device with an enhanced color gamut according to still another exemplary embodiment of the present disclosure; and

FIGS. 9A to 11B are diagrams illustrating experimental results of the head mount display device with an enhanced color gamut according to the exemplary embodiment of the present disclosure.

### DETAILED DESCRIPTION OF THE EMBODIMENT

Various exemplary embodiments described in the present document are illustrative for the purpose of clearly describing the technical idea of the present disclosure, and are not intended to be limited to specific exemplary embodiments. The technical idea of the present disclosure includes various modifications, equivalents, alternatives, and exemplary embodiments selectively combined from all or part of each exemplary embodiment described in this document. In addition, the scope of the technical idea of the present disclosure is not limited to various exemplary embodiments or specific descriptions thereof presented below.

Unless otherwise defined, terms used in this document, including technical or scientific terms, may have meanings commonly understood by those skilled in the art to which the present disclosure pertains.

Expressions such as “include”, “may include”, “comprise”, “may comprise”, “have”, “may have”, etc., used in this document refer to the target feature (e.g., a function, an operation, or a component, etc.) is present and does not exclude the presence of other additional features. In other words, such expressions should be understood as open-ended terms that imply the possibility of including other exemplary embodiments.

Singular expressions described in the present disclosure may include plural meanings unless otherwise stated, which applies to singular expressions described in the claims as well.

Unless the context dictates otherwise, expressions such as “first”, “second”, or “1 st” or “2nd” used in this document are used to distinguish one object from another when referring to a plurality of objects of the same type and do not limit the order or importance of the objects in question.

As used herein, expressions such as “A, B, and C,” “A, B, or C,” “at least one of A, B, and C,” “at least one of A, B, or C”, etc., may refer to each listed item or all possible combinations of listed items. For example, “at least one of A or B” may refer to both (1) at least one A, (2) at least one B, (3) at least one A and at least one B.

As used in this document, the expression “˜based on” is used to describe one or more factors affecting the decision, act of judgment, or action described in the phrase or sentence containing the expression, and this expression does not exclude additional factors influencing the decision, or act or action of judgment.

Hereinafter, various exemplary embodiments of the present disclosure will be described in detail with reference to the accompanying drawings. In the accompanying drawings and descriptions of the drawings, identical or substantially equivalent components may be assigned the same reference numerals. In addition, in the description of various exemplary embodiments below, duplicate descriptions of the same or corresponding components may be omitted, but this does not mean that the corresponding components are not included in the exemplary embodiments.

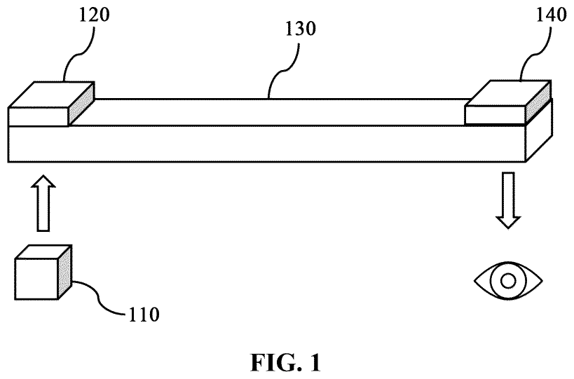

FIG. 1 is a diagram showing a head mount display device with an enhanced color gamut according to an exemplary embodiment of the present disclosure.

Referring to FIG. 1, a head mount display device 100 with an enhanced color gamut according to an exemplary embodiment of the present disclosure includes an optical output device 110, a first diffraction grating 120, a waveguide 130, and a second diffraction grating 140.

The optical output device 110 outputs light corresponding to an image to be output on the head mount display.

In this case, the optical output device 110 may output light corresponding to an image to be displayed to a user to the head mount display.

For example, the optical output device 110 may include a beam projector that projects an image, a neutral density (ND) filter that adjusts the intensity of light, and a lens that couples the light to a central axis.

The first diffraction grating 120 diffracts the output light.

In this case, the diffraction grating is an optical element that diffracts incident light in different directions, and the direction of diffraction may be determined depending on the arrangement of the grating and the wavelength of light.

The first diffraction grating 120 may diffract the light output from the optical output device 110.

The waveguide 130 totally reflects the light diffracted by the first diffraction grating 120.

In this case, the waveguide 130 is a transmission path for transmitting light diffracted by the first diffraction grating 120, and the diffracted light may be totally reflected and transmitted along the waveguide 130.

The second diffraction grating 140 diffracts and outputs the totally reflected light.

Here, the second diffraction grating 140 may diffract the light totally reflected from the waveguide 130 and output the diffracted light to the outside. In addition, the user of the head mount display device 100 with an enhanced color gamut may see the light output to the outside with his/her eyes.

In this case, in the first diffraction grating 120 and the second diffraction grating 140, pitches of R, G, and B of subpixels, respectively, constituting an image are determined according to a predetermined standard.

Here, the image is composed of a plurality of pixels, and one pixel may be composed of a plurality of subpixels. For example, one pixel may include three subpixels of R, G, and B.

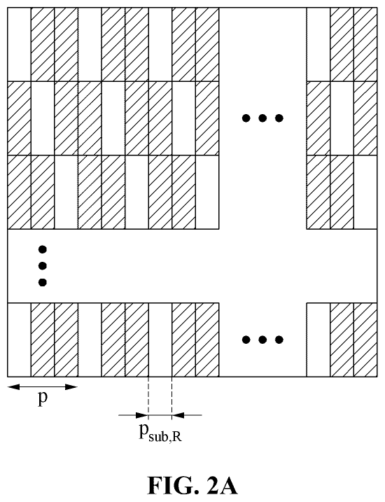

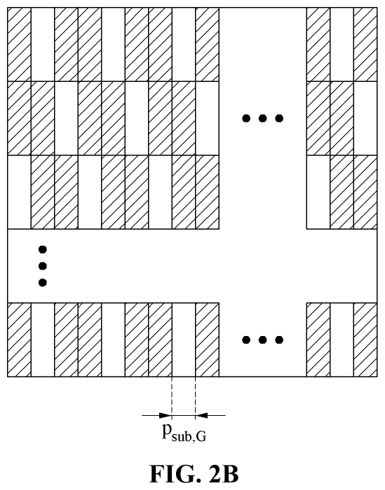

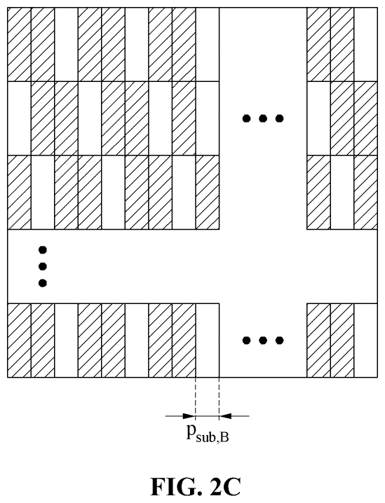

Meanwhile, referring to FIGS. 2A to 2C, in the present disclosure, in a plurality of pixels included in the first diffraction grating 120 and the second diffraction grating 140, the pitches of the R, G, and B subpixels constituting each pixel may be determined according to predetermined standards.

In this way, the first diffraction grating 120 and the second diffraction grating 140, in which the pitches of R, G, and B of subpixels are adjusted, may be said to be the spatially modulated diffraction gratings.

In this case, the standards for determining the pitch sizes of the R, G, and B subpixels will be described in detail later in the exemplary embodiments below.

In other exemplary embodiments, the pitches of each of the R, G, and B may be determined based on the optical efficiency spectrum of each of the R, G, and B.

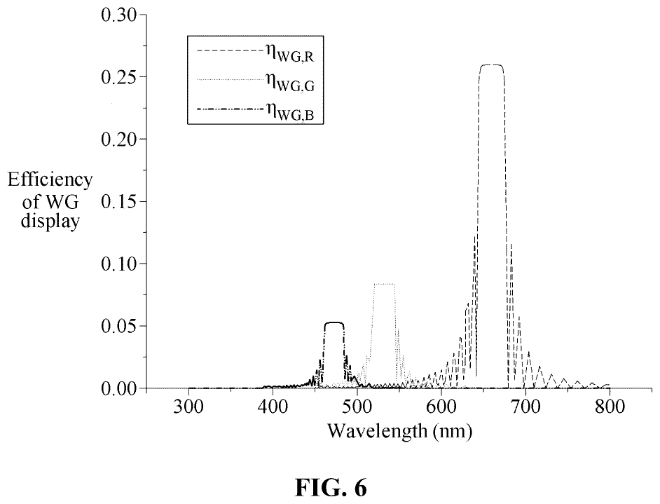

Referring to FIG. 6, the optical efficiency spectrum of the HOE-based waveguide display recorded in monochrome for R, G, and B, respectively, is illustrated. Looking at this, the waveguide display recorded with the R light source shows a relatively high optical efficiency spectrum, but the waveguide display recorded with the G and B light sources shows a relatively low optical efficiency spectrum. This difference may be due to unique characteristics of photopolymer, the raw material of HOE.

As such, when the optical efficiency spectrum of the R, G, and B light sources is not uniform, the range of colors that may be synthesized into three colors is narrowed, and color expression on the display may be limited accordingly.

Therefore, by setting the pitch sizes of each of the R, G, and B subpixel based on the optical efficiency spectrum, it is possible to adjust the area ratio of the recording area for each wavelength, and as a result, to improve the color expression range of the display.

In still another exemplary embodiment, the pitch of each of the R, G, and B may be determined so that the optical efficiency spectrum of each of the R, G, and B is the same within a predetermined range.

In other words, the color expression range of the display may be improved by adjusting the pitch sizes of each of the R, G, and B subpixels so that the optical efficiency spectrum of the R, G, and B light sources is uniform within a predetermined range.

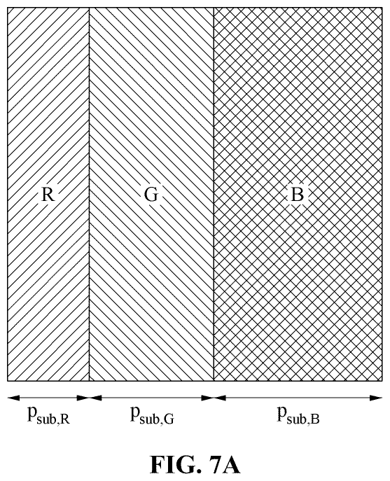

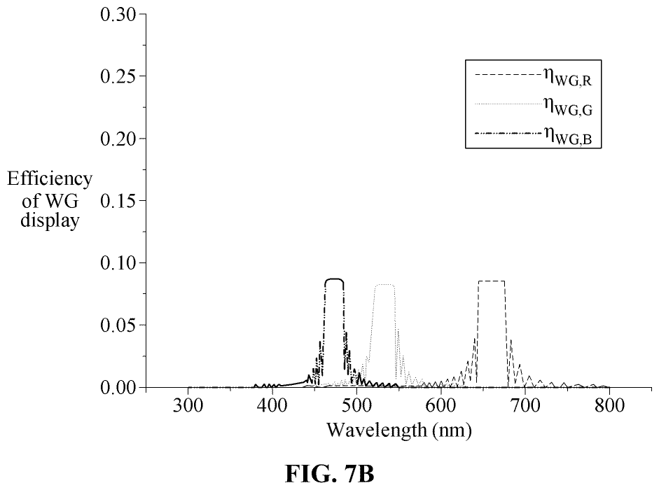

For example, referring to FIGS. 7A and 7B, it may be confirmed that by setting p_{sub,R} to 2 μm, and p_{sub,G} and p_{sub,B} to 3 μm and 4 μm, respectively, for the light spectrum of FIG. 6A, the optical efficiency spectrum of the R, G, and B light sources becomes uniform.

In still another exemplary embodiment, the efficiency spectrum of each of the R, G, and B may be calculated as Equation 1 below.

$${η}_{SMDG , B} ( λ ) = {η}_{B} ( λ ) \times \frac{{p}_{sub , B}}{p} , ( 450 nm < λ < 490 nm ) \\ {η}_{SMDG , G} ( λ ) = {η}_{G} ( λ ) \times \frac{{p}_{sub , G}}{p} , ( 530 nm < λ < 590 nm ) \\ {η}_{SMDG , R} ( λ ) = {η}_{R} ( λ ) \times \frac{{p}_{sub , R}}{p} , ( 630 nm < λ < 700 nm ) \qquad [ Equation 1 ]$$

Here, η_{SMDG,R}(λ), η_{SMDG,G}(λ), and η_{SMDG,B}(λ), denote an optical efficiency spectrum of diffraction grating according to an exemplary embodiment of the present disclosure for the R, G, and B light sources, η_{WG,R}(λ), η_{WG,G}(λ), and η_{WG,B}(λ) denote an optical efficiency spectrum of a hologram optical element (HOE)-based waveguide display recorded in monochrome for a single light source for each of the R, G, and B, p_{sub,R}, p_{sub,G}, and p_{sub,B} denote pitch sizes of R, G, and B subpixels, respectively, and p denotes a pitch of a unit pixel.

In this way, referring to Equation 1, it can be seen that the optical efficiency spectrum of the R, G, and B light sources may be adjusted by adjusting the pitch sizes of each of the R, G, and B subpixels.

In still another exemplary embodiment, the pitch of each of the R, G, and B may be determined based on the optical efficiency spectrum and sensitivity spectrum of each of the R, G, and B.

Meanwhile, three cone cells (short, middle, and long cone) of a retina respond to light when humans perceive color, but the sensitivity of the cone cells may also not be uniform depending on the wavelength band. In addition, this may be corrected by adjusting the pitches of the R, G, and B subpixels.

To this end, the optical efficiency spectrum of each of the R, G, and B and the sensitivity spectrum of detectors such as CCD cameras and human eyes and observers may be used. For example, referring to 8B, the optical efficiency spectrum and sensitivity spectrum of the CCD camera are illustrated, and it can be seen that the maximum sensitivity of the CCD camera is 44%, 52%, and 37% for B, G, and R, respectively.

Meanwhile, the degree to which the human eye perceives R, G, and B may be determined by the distribution of the three cone cells in the retina. Therefore, as described above, by adjusting the pitch sizes of the R, G, and B subpixels, the optical efficiency spectrum of each of the R, G, and B may be adjusted, and as a result, the intensity of light that the human eye perceives the R, G, and B may be adjusted.

In still another exemplary embodiment, the pitches of each of the R, G, and B may be determined so that stimulus values calculated using the optical efficiency spectrum and sensitivity spectrum of each of the R, G, and B are the same within a predetermined range.

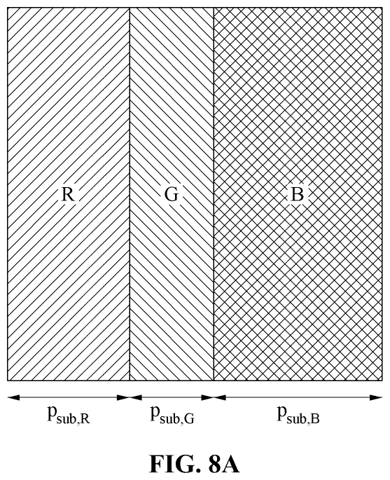

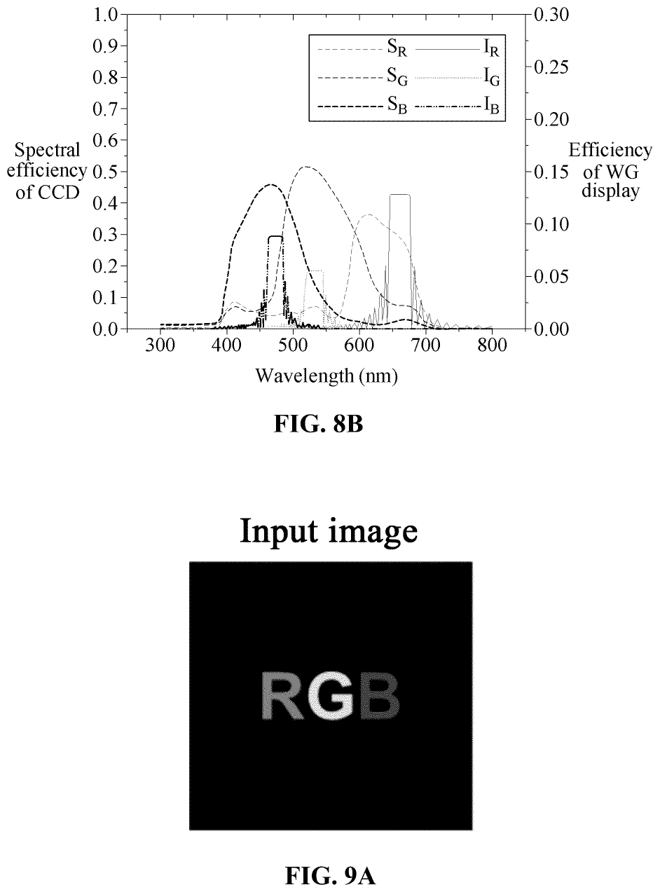

Here, the stimulus value is a value that represents the degree to which the human eye perceives R, G, and B, and in FIG. 8B, may correspond to the area where the optical efficiency spectrum (solid line) and sensitivity spectrum (dotted line) of each of the R, G, and B intersect.

That is, the output of the head mount display device 100 may be optimized by adjusting the pitches of each of the R, G, and B so that the stimulus values of each of the R, G, and B are uniform within a predetermined range.

In still another exemplary embodiment, the stimulus values of each of the R, G, and B may be calculated as Equation 2 below.

$$B ( λ ) = {\int }_{450 nm}^{490 nm} I ( λ ) \times {S}_{B} ( λ ) d λ \\ G ( λ ) = {\int }_{530 nm}^{590 nm} I ( λ ) \times {S}_{G} ( λ ) d λ . \\ R ( λ ) = {\int }_{630 nm}^{700 nm} I ( λ ) \times {S}_{R} ( λ ) d λ \qquad [ Equation 2 ]$$

Here, R(λ), G(λ), and B(λ) denote the stimulus values of each of the R, G, and B of the detector or observer, I(λ) denotes a light output spectrum, and S_{R}(λ), S_{G}(λ), and S_{B}(λ) denote the sensitivity spectrum of each of the R, G, and B of the detector or observer.

As described above, the stimulus value corresponds to the area where the light output spectrum and sensitivity spectrum of each of the R, G, and B intersect, and therefore may be calculated using integral calculation as shown in Equation 2.

In still another exemplary embodiment, the first diffraction grating 120 and the second diffraction grating 140 may be one of a hologram optical element (HOE), a binary grating, a slanted grating, and a blazed grating.

That is, the first diffraction grating 120 and the second diffraction grating 140 may be diffraction gratings of a DOE (diffraction optical element) type manufactured using a semiconductor process.

In the present disclosure, the first diffraction grating 120 and the second diffraction grating 140 are mainly described using the HOE, but the first diffraction grating 120 and the second diffraction grating 140 are not limited to the HOE, and may be applied to various types of diffraction gratings, such as binary grating, slanted grating, and blazed grating, where the pitch size of the subpixel may be adjusted using the semiconductor processes such as glass etching and nano imprinting.

FIGS. 2 to 5 are diagrams for describing the implementation process and simulation of the HOE-type spatially modulated diffraction grating according to an exemplary embodiment of the present disclosure.

In FIGS. 2A to 2C, the area to be recorded on the photomask (white) transmits light, and the other area (black) is coated with chrome to block light.

In addition, p_{sub,R}, p_{sub,G}, and p_{sub,B} are the horizontal lengths (pitches) of the R, G, and B subpixels, and the area ratio of a unit pixel may vary depending on the design of the diffraction grating that reflects the horizontal length. Furthermore, the intensity of diffracted light may be proportional to the area ratio.

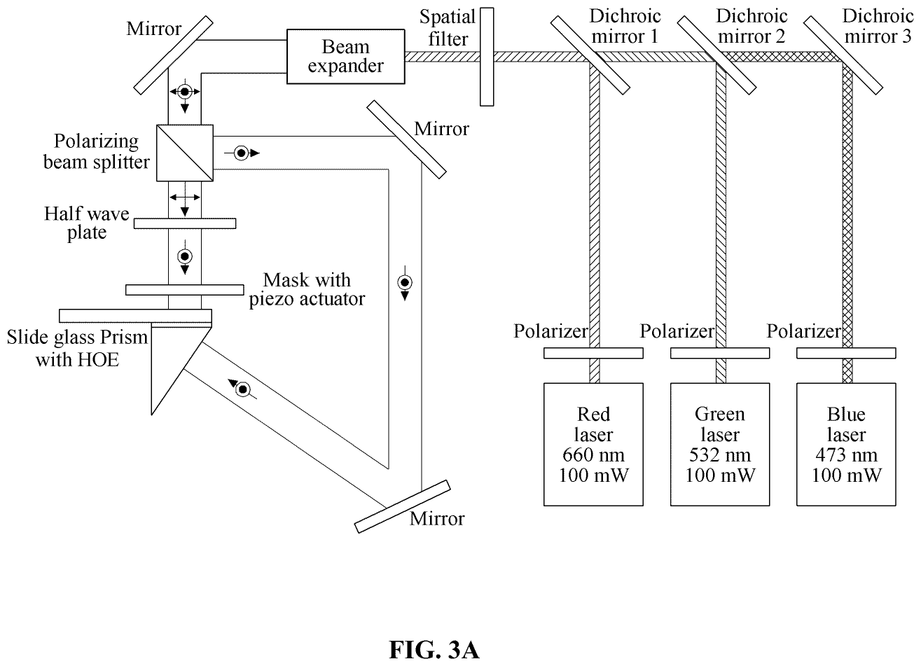

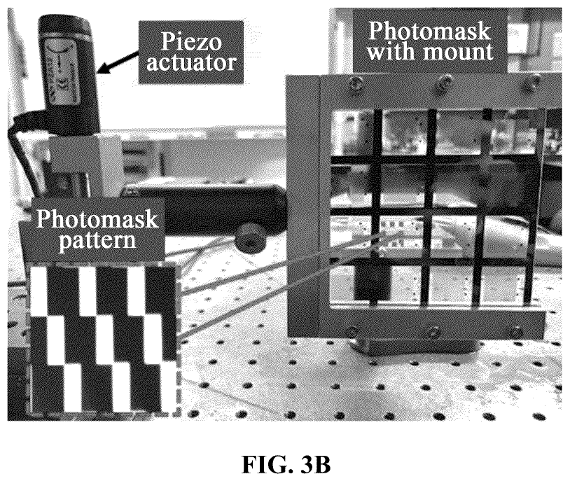

In FIG. 3A, the experimental setup for recording the pattern of the photomask designed on the HOE is illustrated.

A light source reflected by a dichroic mirror is expanded in size by a beam expander and is transmitted or reflected by a polarizing beam splitter.

In this case, the reflected light source is reflected by each mirror, and the transmitted light source is transmitted by the photomask. Thereafter, the two light sources are met in the photopolymer, and the spatially modulated pattern is recorded within the photopolymer.

For the customized subpixelization of the R, G, and B light sources, the spatially modulated patterns corresponding to the photomask alignment are applied to the R, G, and B light sources.

FIG. 3B is the setup for the photomask alignment, and the piezo actuator used is for adjusting the photomask position to correspond to the R, G, and B light sources and the photomask pattern.

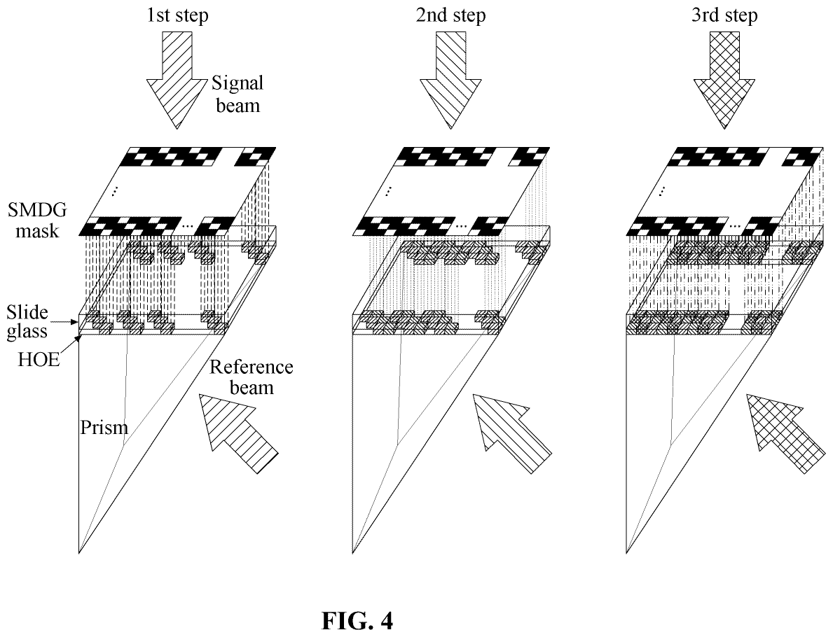

FIG. 4 illustrates the step-by-step recording process for implementing the HOE-type spatially modulated diffraction grating according to an exemplary embodiment of the present disclosure.

In the first step, the photomask pattern corresponding to the R light source is disposed and the R light source is incident. In this case, the light is transmitted only to the area (R light source area) to be recorded and is not transmitted to other areas.

In the second step, the photomask pattern is replaced using the setup in FIG. 3B, and only the area that transmits the photomask is recorded using the G light source.

In the third step, the photomask pattern is replaced as above, and a HOE-type spatially modulated diffraction grating is manufactured by exposing the B light source.

Finally, for curing, the recorded HOE-type spatially modulated diffraction grating is exposed to a halogen lamp for 10 minutes to fix the recorded pattern.

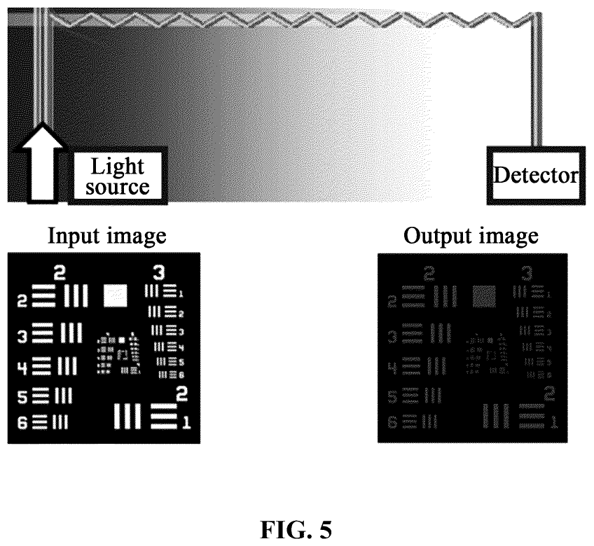

FIG. 5 illustrates the results of ray tracing and imaging simulation using Zemax simulation.

The R, G, and B rays were all diffracted in the same direction and transmitted to the detector, and it can be confirmed that three colors were transmitted through an output image (USAF 1951 target). The reason for the low brightness in the output image is that the efficiency is reduced to ⅓ according to the structure of the HOE-type spatially modulated diffraction grating according to an exemplary embodiment of the present disclosure, which may be solved by increasing the intensity of the input light source.

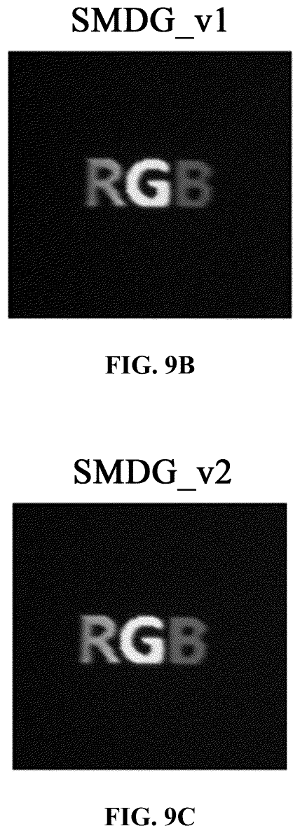

FIGS. 9 to 11 are diagrams illustrating experimental results of the head mount display device with an enhanced color gamut according to the exemplary embodiment of the present disclosure.

FIGS. 9A to 9C illustrate the experimental results in which virtual content (“RGB”) was projected as an input image. In the case of a type (SMDG_v1) with the same subpixel pitch, a G light source is bright and R and B light sources are relatively dark. However, according to an exemplary embodiment of the present disclosure, a waveguide display of a type (SMDG_v2) optimized in consideration of a stimulus value shows uniformly bright images for all R, G, and B light sources.

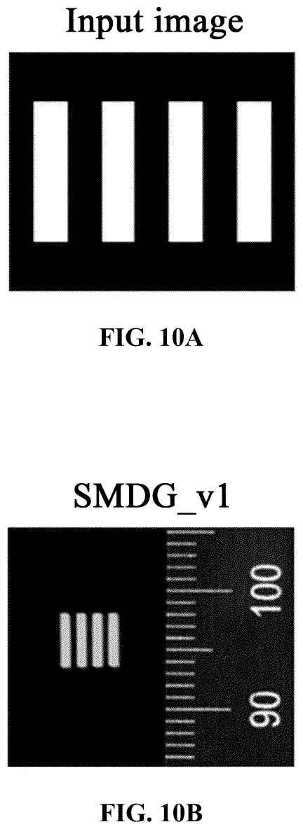

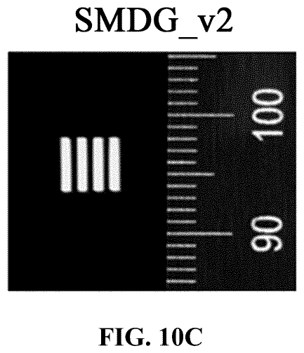

In FIGS. 10A to 10C, for the quantitative analysis of the R, G, and B stimulus values, four white lines were projected as virtual content, and the results demonstrating that the present disclosure may be used in an AR display are shown.

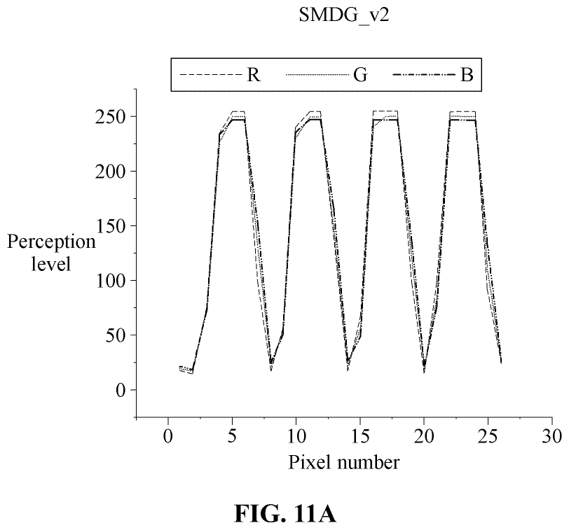

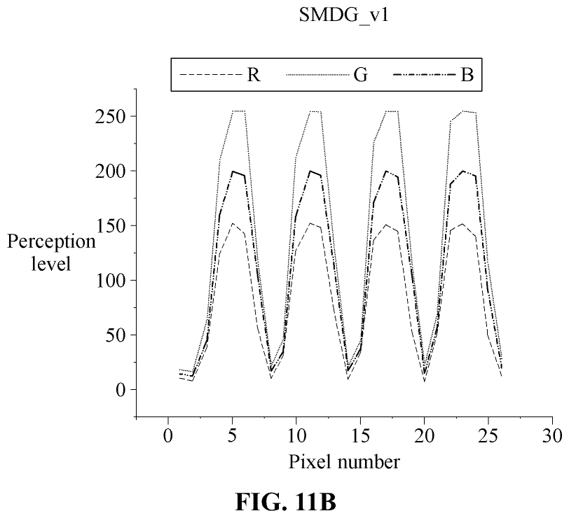

FIGS. 11A and 11B illustrate the results of extracting the virtual content area and filtering the R, G, and B components. It can be seen that the structure (SMDG_v2) optimized in consideration of the stimulus value shows the most uniform output for three colors.

It can be seen intuitively and quantitatively through FIGS. 10 and 11 that the results of the type SMDG_v2 in which the subpixel is optimized are very uniform in R, G, and B compared to the type SMDG_v1 in which the subpixel is not optimized.

Although the technical idea according to the disclosure of the present specification has been described above through various exemplary embodiments, the technical ideas according to the disclosure of this specification include various substitutions, modifications, and changes that can be made within the scope of understanding by those skilled in the art in the technical field to which the disclosure of this specification pertains. In addition, it is to be understood that such substitutions, modifications and alterations may be included within the scope of the appended claims.

What is claimed is:

1. A head mount display device with an enhanced color gamut, comprising:
an optical output device that outputs light corresponding to an image to be output on a head mount display;
a first diffraction grating that diffracts the output light;
a waveguide that totally reflects the light diffracted by the first diffraction grating; and
a second diffraction grating that diffracts and outputs the totally reflected light,
wherein, in the first diffraction grating and the second diffraction grating, pitches of R, G, and B of subpixels constituting the image are determined according to a predetermined standard.

2. The head mount display device of claim 1, wherein the pitches of the R, G, and B are determined based on an optical efficiency spectrum of each of the R, G, and B.

3. The head mount display device of claim 2, wherein the pitches of each of R, G, and B are determined so that the optical efficiency spectrum of each of the R, G, and B is the same within a predetermined range.

4. The head mount display device of claim 2, wherein the optical efficiency spectrum of each of the R, G, and B is calculated as Equation 1 below:
$${η}_{SMDG , B} ( λ ) = {η}_{B} ( λ ) \times \frac{{p}_{sub , B}}{p} , ( 450 nm < λ < 490 nm ) \\ {η}_{SMDG , G} ( λ ) = {η}_{G} ( λ ) \times \frac{{p}_{sub , G}}{p} , ( 530 nm < λ < 590 nm ) \\ {η}_{SMDG , R} ( λ ) = {η}_{R} ( λ ) \times \frac{{p}_{sub , R}}{p} , ( 630 nm < λ < 700 nm ) , \qquad [ Equation 1 ]$$
wherein, η_{SMDG,R}(λ), η_{SMDG,G}(λ), and η_{SMDG,B}(λ), denote the optical efficiency spectrum of R, G, and B light sources, η_{WG,R}(λ), η_{WG,G}(λ), and η_{WG,B}(λ) denote an optical efficiency spectrum of a hologram optical element (HOE)-based waveguide display recorded in monochrome for a single light source for each of the R, G, and B, p_{sub,R}, p_{sub,G}, and p_{sub,B} denote pitch sizes of R, G, and B subpixels, respectively, and p denotes a pitch of a unit pixel.

5. The head mount display device of claim 1, wherein the pitches of each of the R, G, and B are determined based on the optical efficiency spectrum and sensitivity spectrum of each of the R, G, and B.

6. The head mount display device of claim 5, wherein the pitches of each of the R, G, and B are determined so that stimulus values calculated using the optical efficiency spectrum and sensitivity spectrum of each of the R, G, and B are the same within a predetermined range.

7. The head mount display device of claim 6, wherein the stimulus values of each of the R, G, and B are calculated as Equation 2 below:
$$B ( λ ) = {\int }_{450 nm}^{490 nm} I ( λ ) \times {S}_{B} ( λ ) d λ \\ G ( λ ) = {\int }_{530 nm}^{590 nm} I ( λ ) \times {S}_{G} ( λ ) d λ . \\ R ( λ ) = {\int }_{630 nm}^{700 nm} I ( λ ) \times {S}_{R} ( λ ) d λ , \qquad [ Equation 2 ]$$
wherein, R(λ), G(λ), and B(λ) denote the stimulus values of each of the R, G, and B, I(λ) denotes a light output spectrum, and S_{R}(λ), S_{G}(λ), and S_{B}(λ) denote the sensitivity spectrum of each of the R, G, and B.

8. The head mount display device of claim 1, wherein the first diffraction grating and the second diffraction grating are one of a hologram optical element (HOE), a binary grating, a slanted grating, and a blazed grating.
